(19) United States
(12) Patent Application Publication
(10) Pub. No.: US 2026/0225591 A1
(43) Pub. Date: Aug. 6, 2026

(54) MOBILE OBJECT CONTROL DEVICE, MOBILE OBJECT CONTROL METHOD, AND NON TRANSITORY STORAGE MEDIUM

(71) Applicant: HONDA MOTOR CO., LTD., Tokyo (JP)

(72) Inventor: Shinya Sato, Tokyo (JP)

(21) Appl. No.: 19/460,376

(22) Filed: Jan. 27, 2026

(30) Foreign Application Priority Data
Feb. 5, 2025 (JP) 2025-017650

(51) Int. Cl. B60W 30/095

(52) U.S. Cl. CPC B60W 30/0956; B60W 2554/803

(57) ABSTRACT

A control device recognizes a physical object near a mobile object, determines whether or not there is a possibility that an intersecting object intersecting a travel direction of the mobile object will enter an intersecting determination range that is an area set in front of the mobile object when the intersecting object is located near the mobile object based on a recognition result; and when the intersecting object is located at a position separated from the mobile object in the travel direction by a predetermined distance or more, varies a degree of reduction of a longitudinal length, which is a length in a longitudinal direction of the intersecting determination range, based on a margin time predicted as a period of time until a reference position of the intersecting object reaches a reference position set for the mobile object in a process of reducing the intersecting determination range.

### CROSS-REFERENCE TO RELATED APPLICATION

Priority is claimed on Japanese Patent Application No. 2025-017650, filed February 5, 2025, the content of which is incorporated herein by reference.

### BACKGROUND

### Field of the Invention

The present invention relates to a mobile object control device, a mobile object control method, and a non-transitory storage medium.

### Description of Related Art

Recently, efforts to provide access to sustainable transportation systems have been increasingly active in consideration of vulnerable individuals among participants in transportation. For this realization, research and development (R&D) related to preventive safety technology related to driving assistance for assisting a driver in driving has focused on further improving traffic safety and convenience. For example, a driving assistance device for setting a virtual intersecting determination range in front of a host vehicle, determining whether or not there is a possibility that the intersecting determination range will intersect another vehicle when the host vehicle approaches an intersection, and provides an alert to the driver of the host vehicle when such a possibility exists is known (Japanese Unexamined Patent Application, First Publication No. 2016-095697).

### SUMMARY

Meanwhile, conventional driving assistance devices cannot appropriately determine a possibility that another vehicle will intersect an intersecting determination range of a host vehicle. For example, there are cases where a size of the set intersecting determination range is not appropriate, and as a result, it may not be possible to accurately determine a possibility that another vehicle will intersect the intersecting determination range of the host vehicle.

In order to solve the above problems, an objective of the present invention is to provide a mobile object control device, a mobile object control method, and a non-transitory storage medium that enable an intersecting determination range, which is set in front of a host vehicle, to be appropriately set. More specifically, it is possible to variably set an intersecting determination range based on a position or a travel direction of another vehicle. It is possible to appropriately determine a possibility that another vehicle will enter the intersecting determination range using the intersecting determination range. Also, the present invention contributes to the development of sustainable transportation systems.

A mobile object control device, a mobile object control method, and a non-transitory storage medium according to the present invention adopt the following configurations.

(1): According to an aspect of the present invention, there is provided a mobile object control device including: a non-transitory storage medium storing computer-readable instructions; and one or more processors connected to the non-transitory storage medium, the processor executing the computer-readable instructions to: recognize a physical object near a mobile object and thereby obtaining a recognition result; determine whether or not there is a possibility that an intersecting object intersecting a travel direction of the mobile object will enter an intersecting determination range that is an area set in front of the mobile object when the intersecting object is located near the mobile object based on the recognition result; and when the intersecting object is located at a position separated from the mobile object in the travel direction by a predetermined distance or more, perform a process for reducing the intersecting determination range, wherein the process is to vary a degree of reduction of a longitudinal length, which is a length in a longitudinal direction of the intersecting determination range, based on a margin time predicted as a period of time until a reference position of the intersecting object reaches a reference position set for the mobile object.

(2): In the above-described aspect (1), the processor executes the computer-readable instructions to increase the degree of reduction as the margin time increases.

(3): In the above-described aspect (2), the processor executes the computer-readable instructions to: when the margin time is shorter than a reference time, set the length of the intersecting determination range to a predetermined length or more; and when the margin time is greater than or equal to the reference time, set the length of the intersecting determination range to less than the predetermined length and increase the degree of reduction as the margin time increases.

(4): In the above-described aspect (3), the processor executes the computer-readable instructions to: when the intersecting object is not separated from the mobile object in the travel direction by the predetermined distance or more, set the length of the intersecting determination range to the predetermined length; and when the intersecting object is separated from the mobile object in the travel direction by the predetermined distance or more, decide the length of the intersecting determination range based on the margin time.

(5): In the above-described aspect (1), the processor executes the computer- readable instructions to change the longitudinal length based on an error distance, and the error distance is a length calculated based on the margin time and an error index indicating a degree of error detection of the recognition or a sensor configured to provide information about the intersecting object.

(6): In the above-described aspect (5), the error index is a movement speed of a lateral direction relative to a travel direction of the intersecting object that is erroneously detected.

(7): In the above-described aspect (5), the processor executes the computer-readable instructions to variably reduce the longitudinal length by subtracting the error distance from a predetermined length, the predetermined length is a length of a target range in which the intersecting object is detected in a forward intersecting notification, and the forward intersecting notification is a process of providing a notification of approaching of the intersecting object that is likely to intersect a forward direction of the mobile object when the mobile object is moving at a low speed or is stopped.

(8): In the above-described aspect (5), the processor executes the computer-readable instructions to variably reduce the longitudinal length based on a predetermined length and the error length, and set an upper limit of the longitudinal length, the upper limit being shorter than the predetermined length.

(9): In the above-described aspect (8), the processor executes the computer-readable instructions to set the upper limit greater than a width of one lane in a width direction and less than a width of three lanes in a width direction using the lane width as a reference.

(10): In the above-described aspect (1), the processor executes the computer-readable instructions to control the mobile object so that the mobile object and the intersecting object do not approach each other when it is determined that there is a possibility that the intersecting object will enter the intersecting determination range.

(11): In the above-described aspect (7), the processor executes the computer-readable instructions to suppress the approach by executing one or more of (A) a process of controlling a speed of the mobile object, (B) a process of controlling steering of the mobile object, and (C) a process of outputting a warning for a driver of the mobile object.

(12): According to an aspect of the present invention, there is provided a mobile object control method including: recognizing, by a computer, a physical object near a mobile object; thereby obtaining, by a computer, a recognition result; determining, by the computer, whether or not there is a possibility that an intersecting object intersecting a travel direction of the mobile object will enter an intersecting determination range that is an area set in front of the mobile object when the intersecting object is located near the mobile object based on the recognition result; and when the intersecting object is located at a position separated from the mobile object in the travel direction by a predetermined distance or more, performing, by a computer, a process for reducing the intersecting determination range, wherein the process is to vary a degree of reduction of a longitudinal length, which is a length in a longitudinal direction of the intersecting determination range, based on a margin time predicted as a period of time until a reference position of the intersecting object reaches a reference position set for the mobile object.

(13): According to an aspect of the present invention, there is provided a non-transitory storage medium storing a program for causing a computer to execute: a process of recognizing a physical object near a mobile object and thereby obtaining a recognition result; a process of determining whether or not there is a possibility that an intersecting object intersecting a travel direction of the mobile object will enter an intersecting determination range that is an area set in front of the mobile object when the intersecting object is located near the mobile object based on the recognition result; and a reduction process of performing, when the intersecting object is located at a position separated from the mobile object in the travel direction by a predetermined distance or more, a process for reducing the intersecting determination range, wherein the reduction process is to vary a degree of reduction of a longitudinal length, which is a length in a longitudinal direction of the intersecting determination range, based on a margin time predicted as a period of time until a reference position of the intersecting object reaches a reference position set for the mobile object.

According to the above-described aspects (1) to (13), the mobile object control device, the mobile object control method, or the non-transitory storage medium enables the intersecting determination range to be appropriately set by varying the degree of reduction of the longitudinal length and reducing the intersecting determination range according to the margin time when the intersecting object is located at the position separated by the predetermined distance or more. In this way, the mobile object control device, the mobile object control method, or the program enables whether or not there is a possibility that the intersecting object will enter the intersecting determination range to be appropriately determined by setting an appropriate intersecting determination range.

According to the above-described aspect (2), the intersecting determination range can be appropriately set by changing the degree of reduction in accordance with a length of the margin time.

According to the above-described aspect (3), the intersecting determination range can be appropriately set by changing the degree of reduction according to a length of the margin time relative to a reference time.

According to the above-described aspect (4), the intersecting determination range can be appropriately set by setting the length of the intersecting determination range in accordance with the position where the intersecting object is located.

According to the above-described aspect (5), by changing the longitudinal length based on the error distance according to the error index and the margin time, it is possible to appropriately set the intersecting determination range and it is possible to appropriately determine whether or not there is a possibility that an object to be avoided will enter the intersecting determination range.

According to the above-described aspect (6), by calculating the error distance based on a magnitude of the erroneously detected lateral movement speed, it is possible to appropriately set the intersecting determination range and it is possible to appropriately determine whether or not there is a possibility that the object to be avoided will enter the intersecting determination range.

According to the above-described aspect (7), it is possible to appropriately set the intersecting determination range by deciding the longitudinal length based on a value obtained by subtracting the error distance from the predetermined length.

According to the above-described aspect (8), by setting the upper limit, it is possible to restrict the intersecting object serving as a target for determining whether or not there is a possibility that the object to be avoided will enter and improve the accuracy of determining whether or not there is a possibility that the object to be avoided will enter.

According to the above-described aspect (9), by setting the upper limit using the lane width as the reference, it is possible to specifically restrict the intersecting object serving as a target for determining whether or not there is a possibility that the object to be avoided will enter and it is possible to improve the accuracy of determining whether or not there is a possibility that the object to be avoided will enter.

According to the above-described aspect (10), when it is determined that there is a possibility that the object to be avoided will enter, it is possible to appropriately control the mobile object by preventing the mobile object and the intersecting object from approaching each other.

According to the above-described aspect (11), the mobile object and the intersecting object can be prevented from approaching each other by performing one or more of the control processes (A) to (C), and control according to the surrounding situation is performed.

### BRIEF DESCRIPTION OF THE DRAWINGS

FIG. 1 is a configuration diagram of a vehicle system using a vehicle control system according to an embodiment.

FIG. 2 is a diagram showing an exemplary scene to which a process of the present embodiment is applied.

FIG. 3 is a diagram showing an exemplary scene to which a process of the present embodiment is applied.

FIG. 4 is a diagram showing an exemplary scene to which a process of the present embodiment is applied.

FIG. 5 is a diagram showing an exemplary scene to which a process of the present embodiment is applied.

FIG. 6 is a diagram showing an example of reference information.

FIG. 7 is a flowchart showing an example of a flow of a process executed by a driving assistance device.

FIG. 8 is an explanatory diagram of Comparative Example 1.

FIG. 9 is an explanatory diagram of Comparative Example 2.

FIG. 10 is an explanatory diagram of Comparative Example 3.

FIG. 11 is an explanatory diagram of the intersecting determination range set in the present embodiment.

FIG. 12 is a diagram showing an example of a correlation between an error distance and a margin time.

FIG. 13 is a diagram showing an example of content of reference information.

### DETAILED DESCRIPTION OF THE INVENTION

### Overall configuration

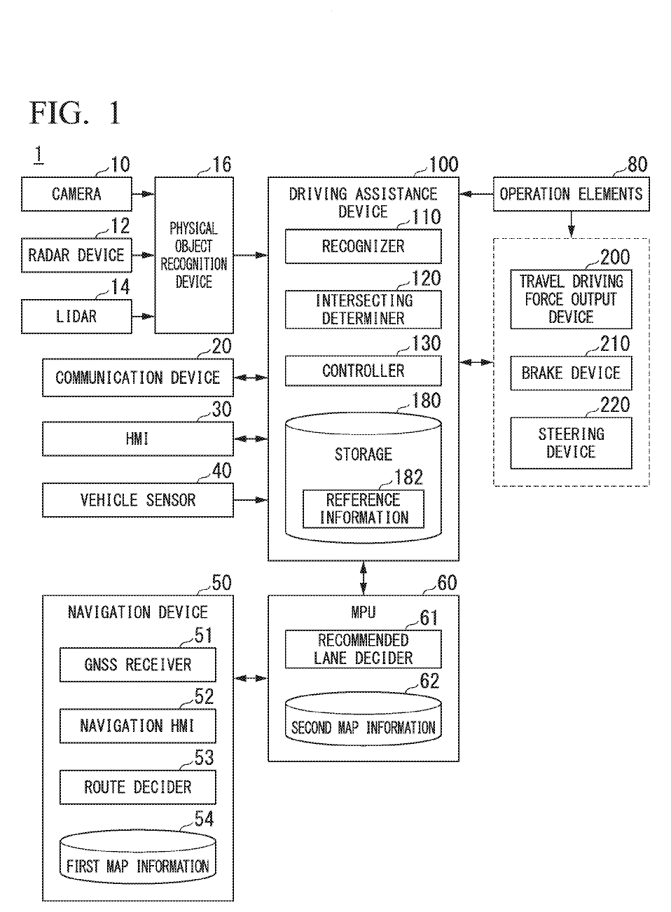

FIG. 1 is a configuration diagram of a vehicle system 1 using a vehicle control system according to an embodiment. A vehicle on which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged. Although the case where the present embodiment is applied to a vehicle will be described, the present invention may be applied to other mobile objects instead of a vehicle.

For example, the vehicle system 1 includes a camera 10, a radar device 12, a light detection and ranging (LIDAR) 14, a physical object recognition device 16, a communication device 20, a human machine interface (HMI) 30, a vehicle sensor 40, a navigation device 50, a map positioning unit (MPU) 60, operation elements 80, a driving assistance device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. The driving assistance device 100 is an example of a “mobile object control device.”

For example, the camera 10 is a digital camera using a solid-state imaging element such as a charge-coupled device (CCD) or a complementary metal oxide semiconductor (CMOS). The camera 10 is attached to any location on a vehicle (hereinafter, a vehicle M) where the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position of a physical object (a distance from the physical object and a direction of the physical object) by detecting radio waves (reflected waves) reflected by the physical object. The radar device 12 is attached to any location on the vehicle M. The radar device 12 may detect a position and a speed of the physical object in a frequency-modulated continuous wave (FM-CW) scheme. The radar device 12, for example, is also mounted on the front corners (left and right) of the vehicle M. Thereby, the radar device 12 can detect physical objects that are about to cross in front of the vehicle M.

The LIDAR 14 radiates light (or electromagnetic waves having a wavelength close to that of light) around the vehicle M and measures scattered light. The LIDAR 14 detects a distance from a target based on a period of time from light emission to light reception. The radiated light is, for example, pulsed laser light. The LIDAR 14 is attached to any location of the vehicle M.

The physical object recognition device 16 performs a sensor fusion process on detection results from some or all of the camera 10, the radar device 12, and the LIDAR 14 to recognize a position, type, speed, and the like of the physical object. The physical object recognition device 16 outputs a recognition result to the driving assistance device 100. The physical object recognition device 16 may output detection results of the camera 10, the radar device 12, and the LIDAR 14 to the driving assistance device 100 as they are. The physical object recognition device 16 may be omitted from the vehicle system 1.

The communication device 20, for example, communicates with another vehicle located in the vicinity of the vehicle M using a cellular network, a Wi-Fi network, Bluetooth (registered trademark), dedicated short-range communication (DSRC), or the like or communicates with various types of server devices via a radio base station.

The HMI 30 presents various types of information to an occupant of the vehicle M and receives an input operation from the occupant. The HMI 30 includes various types of display devices, a speaker, a buzzer, a touch panel, a switch, keys, and the like. The HMI 30 includes a display device. The display device is provided at a central portion of an instrument panel of the vehicle M and is, for example, a display device, i.e., a multi-information display, configured to display various information in the vehicle M such as a speedometer indicating a traveling speed of the vehicle M or a tachometer indicating the number of rotations (a rotational speed) of the internal combustion engine provided in the vehicle M.

The vehicle sensor 40 includes a vehicle speed sensor configured to detect the speed of the vehicle M, an acceleration sensor configured to detect acceleration, a yaw rate sensor configured to detect angular velocity around a vertical axis, a direction sensor configured to detect a direction of the vehicle M, a sensor configured to detect a rotation angle of steering, and the like.

For example, the navigation device 50 includes a global navigation satellite system (GNSS) receiver 51, a navigation HMI 52, and a route decider 53. The navigation device 50 holds first map information 54 in a storage device such as a hard disk drive (HDD) or a flash memory. The GNSS receiver 51 identifies a position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may provide route guidance using the navigation HMI 52 based on the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

The MPU 60 includes, for example, a recommended lane decider 61, and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. The recommended lane decider 61 decides in what lane numbered from the left the vehicle will travel. The recommended lane decider 61 decides the recommended lane so that the vehicle M can travel along a reasonable route for traveling to a branching destination when there is a branch point on the route on the map. For example, when the vehicle M reaches a position that is a predetermined distance before a branch route that the vehicle M is scheduled to enter, the recommended lane decider 61 decides a lane connecting to the branch route as the recommended lane. The recommended lane decider 61 and the second map information 62 may be a functional unit or information included in another device such as the driving assistance device 100. Information about the recommended lane, for example, is provided to the driver via the HMI.

The second map information 62 is map information with higher accuracy than the first map information 54. The second map information 62 includes, for example, information about a center of a lane, information about a boundary of the lane, or the like. The second map information 62 may include road information, traffic regulation information, address information (address/postal code), facility information, telephone number information, and the like. The second map information 62 may be updated at any time by the communication device 20 communicating with other devices.

The operation elements 80 include, for example, a steering wheel, an accelerator pedal, a brake pedal, a shift lever, and other operation elements. A sensor for detecting an amount of operation or the presence or absence of an operation is attached to the operation element 80 and a detection result thereof is output to the driving assistance device 100 or some or all of the travel driving force output device 200, the brake device 210, and the steering device 220. The steering wheel does not necessarily have to be annular and may be in the form of a variant steering wheel, a joystick, a button, or the like.

The driving assistance device 100 includes, for example, a recognizer 110, an intersecting determiner 120, a controller 130, and a storage 180. The recognizer 110, the intersecting determiner 120, and the controller 130 are implemented, for example, by a hardware processor such as a central processing unit (CPU) executing a program (software). Some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The program may be pre-stored in the storage 180 (a storage device including a non-transitory storage medium) such as an HDD or a flash memory in the driving assistance device 100 or may be stored in a removable storage medium such as a DVD or a CD-ROM and installed in an HDD or a flash memory of the driving assistance device 100 when the storage medium (the non-transitory storage medium) is mounted in a drive device. The storage 180, for example, stores reference information 182, which will be described below. The controller 130 or a functional configuration in which the intersecting determiner 120 and the controller 130 are combined is an example of a “controller.”

On the basis of information input from the camera 10, the radar device 12, and the LIDAR 14 via the physical object recognition device 16, the recognizer 110 recognizes a state of a position, velocity, acceleration, or the like of a physical object in the vicinity of the vehicle M. The position of the physical object, for example, is recognized as a position of an absolute coordinate system having a representative point of the vehicle M (a center of gravity, a drive shaft center, or the like) as the origin, and is used for control. The position of the physical object may be represented by a representative point such as the center of gravity or a corner of the physical object or may be represented by an area. The “state” of the physical object may include the acceleration or jerk of the physical object, or the “action state” (e.g., whether or not the vehicle is changing lanes or is about to change lanes).

The recognizer 110 recognizes, for example, a travel path of the vehicle M, a travel path located in another nearby area, and the like. The travel path is a lane in which the vehicle M is traveling (a travel lane), an oncoming lane opposite to the travel lane, or the like. For example, the recognizer 110 recognizes the travel path by comparing a pattern of road markings (e.g., an arrangement of solid lines SL and broken lines) obtained from the second map information 62 with a pattern of road markings in the vicinity of the vehicle M recognized from an image captured by the camera 10. The recognizer 110 may recognize a travel path by recognizing a travel path boundary (a road boundary) including a road marking, a road shoulder, a curb, a median strip, a guardrail, and the like as well as a road marking. In this recognition, a position of the vehicle M acquired from the navigation device 50 or a processing result of the INS may be taken into account. The recognizer 110 recognizes a temporary stop line, an obstacle, a red traffic light, and a toll gate located near the vehicle M, and other road events.

The recognizer 110 recognizes a behavior of the vehicle M on the basis of a detection result of the vehicle sensor 40. For example, when the travel path is recognized, the recognizer 110 recognizes a position or posture of the vehicle M with respect to the travel path. For example, the recognizer 110 may recognize a deviation of a reference point of the vehicle M from the center of the lane and an angle formed between the travel direction of the vehicle M and a line connected to the center of the lane as a relative position and posture of the vehicle M related to the travel path. Alternatively, the recognizer 110 may recognize the position of the reference point of the vehicle M for any side end of the travel path (the road marking or the road boundary) or the like as a position of the vehicle M relative to the travel path.

When the recognizer 110 has recognized an intersecting object that intersects the travel direction of the vehicle M in front of the vehicle M, the intersecting determiner 120 determines whether or not there is a possibility that the intersecting object will enter the intersecting determination range of the vehicle M. The intersecting determination range is an area set in front of the vehicle M, and its size is changed using a method to be described below. The intersecting determiner 120 generates a predicted route of the intersecting object based on information about the intersecting object. The predicted route is a route along which the reference position of the intersecting object is expected to move in the future. The intersecting determiner 120 generates the predicted route based on the intersecting object’s speed, acceleration, position, travel direction, and the like. The intersecting determiner 120 determines a physical object whose predicted route intersects a travel direction or a reference intersecting determination range of the vehicle M as an intersecting object.

The controller 130 controls the overall configuration included in the driving assistance device 100 and the vehicle system 1. For example, the controller 130 may control the steering of the vehicle M, control the speed of the vehicle M, or control the HMI 30 to provide information to the driver. Details of the processes performed by the intersecting determiner 120 and the controller 130 will be described below.

The travel driving force output device 200 outputs a travel driving force (torque) for enabling the traveling of the vehicle to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the driving assistance device 100 or information input from the operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the driving assistance device 100 or the information input from the operation element 80 so that brake torque according to a braking operation is output to each wheel.

For example, the steering device 220 includes a steering ECU and an electric motor. For example, the electric motor changes directions of steerable wheels by applying a force to a rack and pinion mechanism. The steering ECU drives the electric motor in accordance with the information input from the driving assistance device 100 or the information input from the operation element 80 to change the directions of the steerable wheels.

### Overview

In the present embodiment, a forward intersecting notification process is performed to notify the driver of the vehicle M of the approach of an intersecting vehicle that is likely to cross in front of the vehicle M. A so-called forward intersecting vehicle warning (approach suppression control) is implemented. For example, at the time of stopping at intersections with limited visibility or the like, during starting, or during slow movement, a notification of information about intersecting vehicles approaching from the left and right front is provided to the driver to assist in avoiding the approach. In the present embodiment, when the vehicle M enters an intersection and an intersecting vehicle is recognized in front of the vehicle M by the recognizer 110, the intersecting determiner 120 determines whether or not there is a possibility that the intersecting vehicle will enter the intersecting determination range.

### Details of process

In the present embodiment, the intersecting determination range is controlled according to a position where the intersecting object is located and a margin time. When the intersecting object is located at a position separated from the vehicle M in the travel direction (longitudinal direction) by a predetermined distance or more, the intersecting determiner 120 reduces a length in a longitudinal direction of the intersecting determination range, based on a margin time that is a period of time until a reference position of the intersecting object reaches a reference position set for the vehicle M in a process of reducing the intersecting determination range.

The predetermined distance is a preset distance. The predetermined distance, for example, may be decided in accordance with types or specifications of the camera 10, the radar device 12, and the LIDAR 14 or may be changed with a width of a lane in which the intersecting vehicle travels or the like.

For the intersecting object, for example, a physical object located within the set distance relative to the travel direction of the vehicle M may be a target.

The reference position set for the vehicle M, for example, may be any position on the travel path of the vehicle M (for example, within the set distance) or any position within the intersecting determination range. The length of the intersecting determination range in the longitudinal direction may, for example, be a predetermined distance or any other distance.

Although an example in which the vehicle is traveling at a slow or predetermined speed (e.g., low speed) or the like will be described below, a process similar to that when the vehicle is stopped or traveling at a speed greater than or equal to the predetermined speed may be performed.

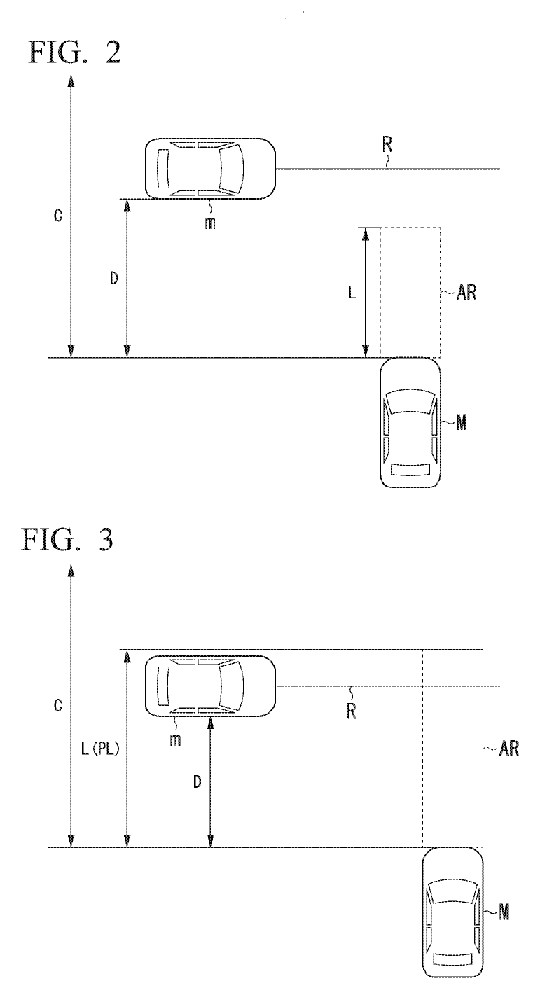

FIG. 2 is a diagram showing an exemplary scene to which the process of the present embodiment is applied. In FIG. 2, the vehicle M is traveling slowly, and an intersecting vehicle m is traveling straight in a direction intersecting the travel direction of the vehicle M. The intersecting vehicle m is an example of an intersecting object. An intersecting determination range AR is an area set in front of the vehicle M. A width of the intersecting determination range AR in a width direction is set, for example, based on the width of the vehicle M. For example, a width of the intersecting determination range AR in the width direction may be, for example, equal to or approximately the same as the width of the vehicle M. A longitudinal distance D is a distance in the longitudinal direction between a predetermined position of the vehicle M and a predetermined position of the intersecting vehicle m. The longitudinal length L is a length of the intersecting determination range AR in the longitudinal direction. A set distance C (predetermined length) is a length of a target range for detecting an intersecting object in a forward intersecting vehicle warning (approach suppression control). A predicted route R is a predicted route of the intersecting vehicle m. The predicted route R is a route predicted by the driving assistance device 100 based on detection results of the camera 10, the radar device 12, and the LIDAR 14.

A predetermined position of each of the vehicle M and the intersecting vehicle m may be, for example, a front-center position of each vehicle, a left or right end, or a rear position. However, the predetermined position is not limited to this position and it is only necessary for the predetermined position to be a position indicating an arbitrarily decided specific part in the shape of the vehicle. The predetermined position may be preset or may be changed during traveling in accordance with a situation of the vehicle. The predetermined position may differ according to each vehicle.

In FIG. 2, the vehicle M is attempting to slowly enter the intersection from a position before the intersection under the driver’s control. At this time, the recognizer 110 recognizes the intersecting vehicle m in front of the vehicle M. Furthermore, the intersecting determiner 120 derives the longitudinal distance D. The intersecting determiner 120 determines whether or not the longitudinal distance D is within the set distance C. When the longitudinal distance D is within the set distance C, the intersecting vehicle m is determined to be an intersecting vehicle m that is a processing target. In this case, the intersecting determiner 120 determines whether or not the longitudinal distance D is greater than or equal to the predetermined distance.

As shown in FIG. 3, when it is determined that the longitudinal distance D is less than a predetermined distance PL, the intersecting determiner 120 does not reduce the intersecting determination range AR. In other words, when the intersecting vehicle m is located within the reference intersecting determination range AR in the longitudinal direction, the reference intersecting determination range AR is set. The reference intersecting determination range AR is the intersecting determination range AR whose longitudinal length L is the above-described predetermined distance PL (an upper limit A to described below).

When it is determined that the longitudinal distance D is greater than or equal to the predetermined distance PL, the intersecting determiner 120 decides to reduce the intersecting determination range AR relative to the reference intersecting determination range AR. The intersecting determiner 120 calculates a margin time TTC, which is a period of time until the intersecting vehicle m reaches the reference position set relative to the vehicle M, based on the above-described predicted route R and the reference position.

Subsequently, the intersecting determiner 120 decides the longitudinal length L based on preset parameters and the calculated margin time TTC with reference to the reference information 182. For example, in the above-described process, the intersecting determiner 120 variably decides the degree of reduction of the longitudinal length L to reduce the intersecting determination range AR. The set parameter is a parameter indicating a correlation between the longitudinal length L and the margin time TTC. A concept for generating the set parameter will be described below.

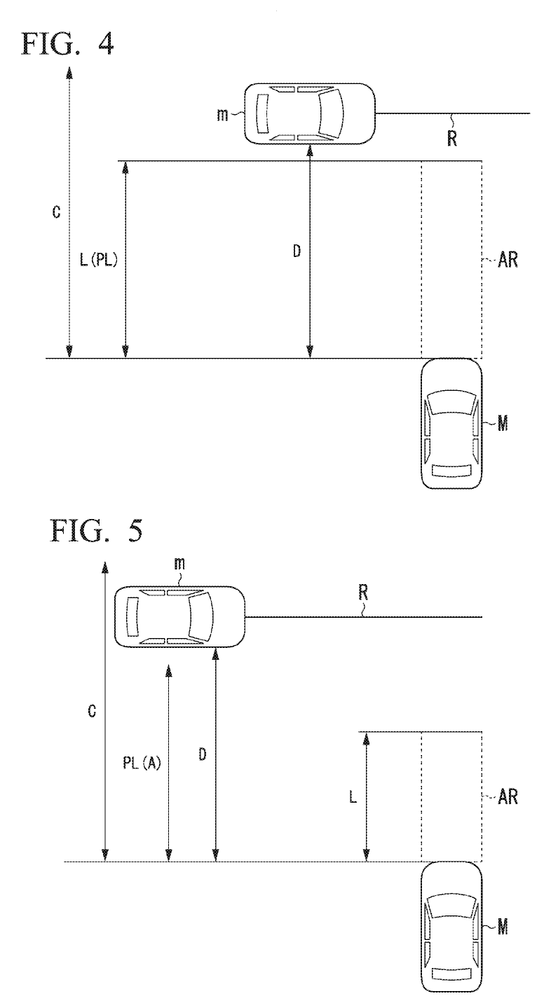

If the longitudinal distance D is greater than or equal to the predetermined distance PL when the margin time TTC is less than a predetermined value (or less than the reference time), the intersecting determiner 120 sets the intersecting determination range AR with the longitudinal length L that is the predetermined distance PL (upper limit A) as shown in FIG. 4.

If it is determined that the longitudinal distance D is greater than or equal to the predetermined distance PL, when the margin time TTC is greater than or equal to the predetermined value (greater than or equal to the reference time), the intersecting determiner 120 sets an intersecting determination range AR whose longitudinal length L is a length corresponding to the margin time TTC in a length range shorter than the predetermined distance PL (upper limit A) as shown in FIG. 5.

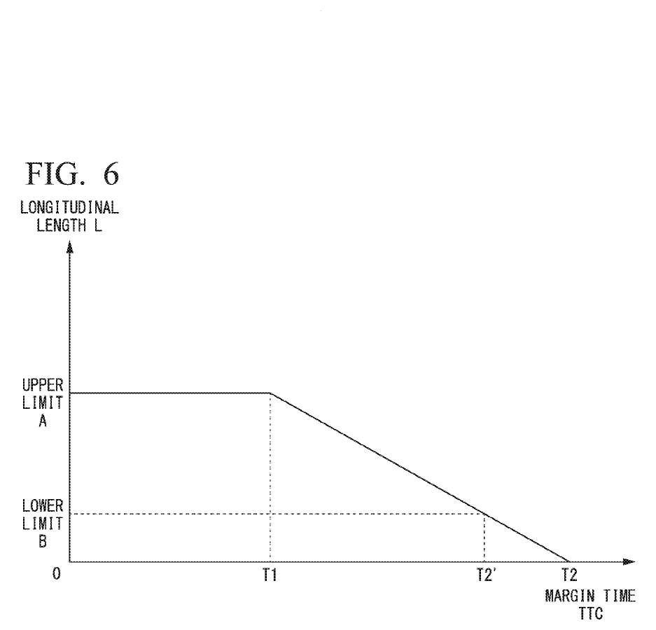

FIG. 6 is a diagram showing an example of the reference information 182. The reference information 182 is information indicating the correlation between the longitudinal length L and the margin time TTC. The vertical axis represents the longitudinal length L, and the horizontal axis represents the margin time TTC. A value of the longitudinal length L decreases as the value of the margin time TTC increases.

An upper limit may be provided for the longitudinal length L. The upper limit is, for example, set based on the width of the lane in which the intersecting vehicle m travels in a width direction. Specifically, the upper limit may be set to a value greater than the width of one lane in the width direction and less than the width of three lanes in the width direction, based on the lane width of the travel lane of the intersecting vehicle m. In FIG. 6, the upper limit A is set as the upper limit of the longitudinal length L. The upper limit A may change with the number of lanes of the road that the vehicle M enters or the speed of the vehicle M. For example, when the number of lanes of the road that the vehicle M enters is two, the upper limit may be decided based on the width or the width corresponding to the two lanes. As the speed of the vehicle M increases, the upper limit A may increase.

A magnitude of the longitudinal length L based on the margin time TTC in FIG. 6 will be specifically described. When a value of the margin time TTC is greater than or equal to 0 and less than time T1, a value of the longitudinal length L is set to the upper limit A. When the value of the margin time TTC is greater than or equal to time T1 and less than time T2, the value of the longitudinal length L decreases as the value of the margin time TTC increases. When the value of the margin time TTC is greater than or equal to time T2, the value of the longitudinal length L is zero.

A lower limit may be provided for the longitudinal length L. The lower limit may be set, for example, in accordance with the length of the vehicle M, the vehicle speed, or the like. In FIG. 6, for example, the value of the longitudinal length L is set to a lower limit B when the value of the margin time TTC is time T2’. In this case, when a value of the margin time TTC is greater than or equal to 0 and less than time T1, the value of the longitudinal length L is the upper limit A. When the value of the margin time TTC is greater than or equal to time T1 and less than time T2’, the value of the longitudinal length L decreases as the value of the margin time TTC increases. When the margin time TTC is greater than or equal to time T2’, the value of the longitudinal length L is set to the lower limit B.

When the intersecting determination range AR is set as described above and it is determined that there is a possibility that the intersecting vehicle m will enter the intersecting determination range AR, the controller 130 may control the vehicle M (approach suppression control). The controller 130 may output a warning to the driver as the approach suppression control. The warning is control for preventing the vehicle M from approaching the intersecting vehicle m. The approach suppression control may include control for speed adjustment assistance and steering assistance. The approach suppression control may be any control for preventing the vehicle M from approaching the intersecting vehicle m. For example, the controller 130 may perform the above-described control when the predicted route of the intersecting vehicle m intersects the intersecting determination range and the margin time TTC until the intersecting vehicle m reaches the intersecting determination range is less than or equal to a threshold.

The warning may be a warning to alert the driver that the vehicle M may approach another vehicle, a warning to alert the driver to reduce the travel speed of the vehicle M, or a warning to alert the driver to drive the vehicle M away from the intersection or other vehicles. The warning may be, for example, a visual display, an audio output, or a vibration of the steering wheel. The warning is not limited to these and may be any alert that draws the driver’s attention. For example, the warning may become stronger as the possibility of approach increases. For example, if the possibility of approach increases after the display, an audio warning may be issued in addition to the display.

Speed adjustment assistance is control for adjusting the speed of the vehicle M. The speed adjustment assistance may include, for example, decreasing the travel speed of the vehicle M to delay the arrival at the intersection serving as a reference of control, increasing the travel speed of the vehicle M to advance the arrival at the intersection serving as a reference of control, or the like. The speed adjustment assistance may include control for stopping the traveling of the vehicle M.

Steering assistance is control for supporting steering of the vehicle M. The steering assistance may include controlling the steering so that vehicle M proceeds in a direction away from the intersection. The steering assistance may, for example, control for supporting steering so that the vehicle M travels at a position where a predetermined distance or more from another vehicle is maintained.

### Flowchart

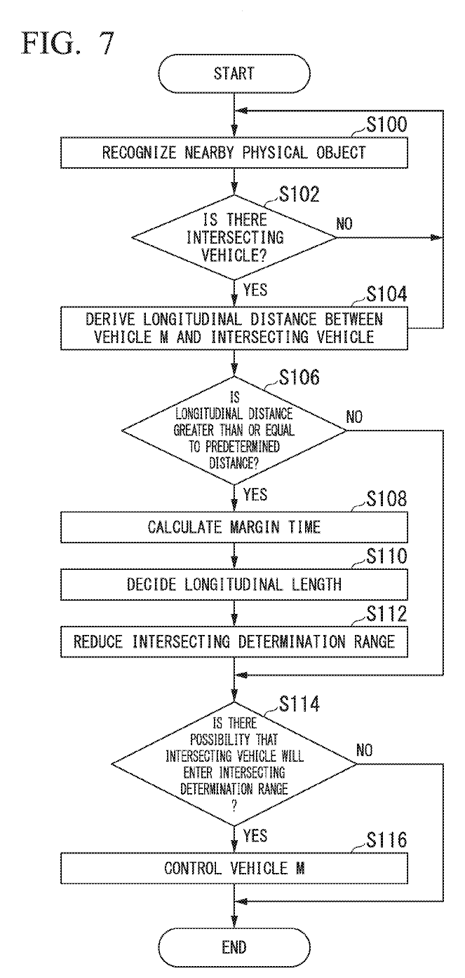

FIG. 7 is a flowchart showing an example of a flow of a process executed by the driving assistance device 100. The flowchart shown in FIG. 7 is executed, for example, when the vehicle M is about to enter an intersection and is traveling at a low speed.

First, the recognizer 110 recognizes physical objects near the vehicle M (step S100). The physical objects near the vehicle M may include, for example, intersecting vehicles. Subsequently, the intersecting determiner 120 determines whether or not an intersecting vehicle is located in front of the vehicle M (step S102).

When it is determined that there is no intersecting vehicle in front of the vehicle M, the process returns to step S100. When it is determined that an intersecting vehicle is located in front of the vehicle M, the intersecting determiner 120 derives a longitudinal distance, which is a distance in the longitudinal direction (the travel direction of the vehicle M) between the reference position of the vehicle M and the reference position of the intersecting vehicle (step S104). When the longitudinal distance exceeds the set distance, because the intersecting vehicle is outside the scope of the present flowchart, the subsequent process will be omitted.

Subsequently, the intersecting determiner 120 determines whether or not the longitudinal distance is greater than or equal to the predetermined distance (step S106). When the longitudinal distance is greater than or equal to the predetermined distance, the intersecting determiner 120 calculates the margin time (step S118).

Subsequently, the intersecting determiner 120 decides the longitudinal length with reference to the reference information 182 (step S110). Based on the decided longitudinal length, the intersecting determiner 120 reduces the intersecting determination range relative to the reference intersecting determination range (step S112).

Subsequently, the intersecting determiner 120 determines whether or not there is a possibility that the intersecting vehicle will enter the intersecting determination range (step S114).

When it is determined that there is a possibility that the intersecting vehicle will enter the intersecting determination range, the controller 130 controls the vehicle M (or executes approach suppression control) (step S116). When it is determined that there is no possibility that the intersecting vehicle will enter the intersecting determination range, the process of the routine of the present flowchart ends.

When it is determined that the longitudinal distance is less than the predetermined distance in the processing of step S106, the length of the intersecting determination range in the longitudinal direction is not reduced and is set to a length of the reference intersecting determination range in the longitudinal direction, and the process proceeds to the processing of step S114. Subsequent processing is similar to that described above. Thereby, the process of the present flowchart ends.

As described above, by appropriately setting the longitudinal length of the intersecting determination range, the driving assistance device 100 can appropriately control the mobile object so that the mobile object and the intersecting object do not approach each other when it is determined that there is a possibility that the intersecting object will enter the intersecting determination range. For example, when the vehicle M is about to enter an intersection with limited visibility, if it is determined that there is a possibility that the intersecting vehicle m will enter the intersecting determination range, the controller 130 can output a warning to notify the driver of the presence of the intersecting vehicle m and alert the driver.

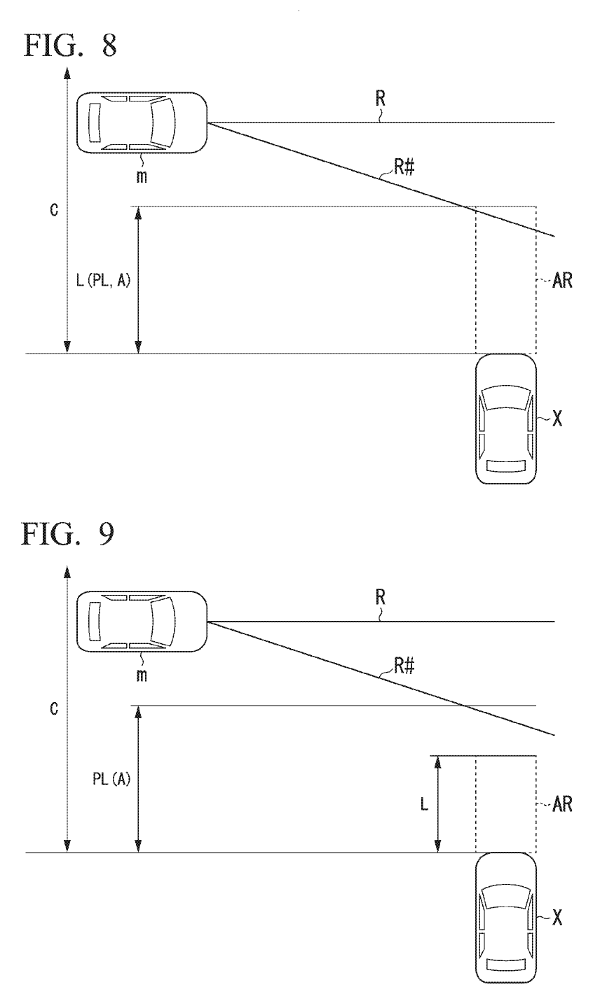

Here, Comparative Examples 1 to 3 will be described. FIG. 8 is an explanatory diagram of Comparative Example 1. Differences from FIG. 2 will be described. The longitudinal length L is the upper limit A (predetermined distance PL), and the intersecting determination range AR is not reduced. A predicted route R# is a predicted route of the intersecting vehicle m including an error distance. The error distance is a length calculated based on a sensor for providing information to the recognizer, such as a camera, a radar device, or an LIDAR, an error index indicating a degree of erroneous detection by the recognizer, and the margin time TTC (e.g., a lateral movement component of the intersecting vehicle m). The error index is a speed of the intersecting vehicle m in the lateral direction. The error distance occurs in the direction toward a vehicle X (the lateral direction of the intersecting vehicle m). A total magnitude of the error distance increases as the margin time increases. The predicted route R is a predicted route of the intersecting vehicle m (a route along which the intersecting vehicle m is actually scheduled to travel) that does not include an error distance. The predicted routes R and R# differ due to the occurrence of the error distance.

The vehicle X generates the predicted route R# based on the information about the intersecting vehicle m. The vehicle X determines whether or not there is a possibility that the intersecting vehicle m will enter the intersecting determination range AR based on the predicted route R# and the intersecting determination range AR. In the case of FIG. 8, the vehicle X determines that there is a possibility that the intersecting vehicle m will enter the intersecting determination range AR and outputs a warning (or executes approach suppression control). In this case, the vehicle X executes the approach suppression control for the intersecting vehicle m that is actually outside the target of the approach suppression control (the intersecting vehicle m that will not actually enter the intersecting determination range AR).

FIG. 9 is an explanatory diagram of Comparative Example 2. Differences from FIG. 8 will be described. To suppress unnecessary execution of approach suppression control as in FIG. 8, as shown in FIG. 9, when a longitudinal distance between a predetermined position of the vehicle X and a predetermined position of the intersecting vehicle m is greater than or equal to the predetermined distance PL, the longitudinal length L is uniformly shortened and the intersecting determination range AR is reduced.

When the intersecting determination range AR is reduced as in FIG. 9, the vehicle X determines that there is no possibility that the intersecting vehicle m will enter the intersecting determination range AR. However, when the intersecting determination range AR is uniformly reduced, a situation as in Comparative Example 3 to be described below may occur.

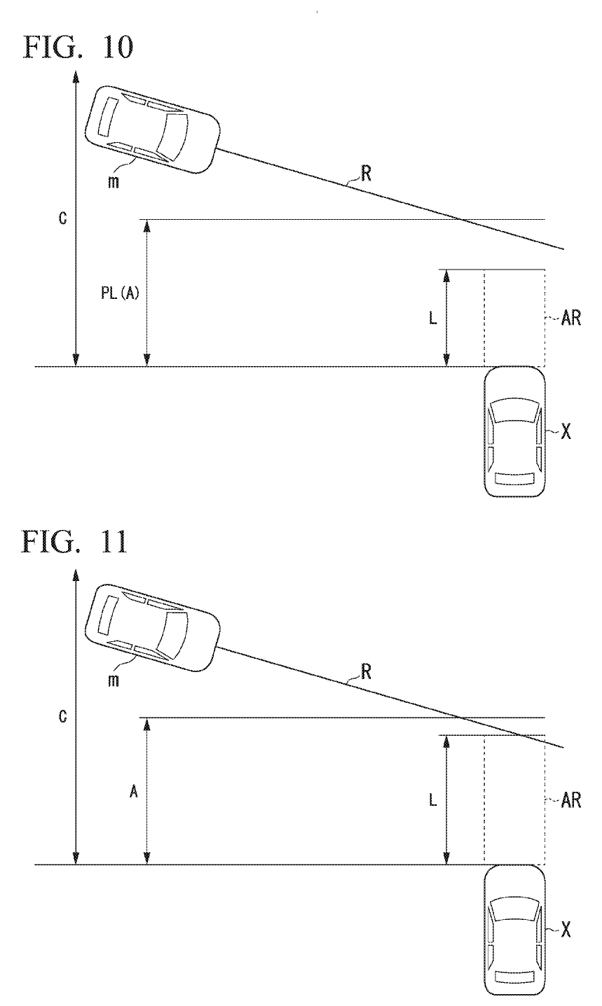

FIG. 10 is an explanatory diagram of Comparative Example 3. Differences from FIG. 9 will be described. In FIG. 10, the intersecting vehicle m moves toward the vehicle X from a diagonally forward direction. In this case, the predicted route R is a route along which the intersecting vehicle m is actually scheduled to travel.

The vehicle X generates the predicted route R based on the information about the intersecting vehicle m. The vehicle X determines whether or not there is a possibility that the intersecting vehicle m will enter the intersecting determination range AR based on the predicted route R and the intersecting determination range AR. In the case of FIG. 10, because the intersecting determination range AR is uniformly reduced, the vehicle X determines that there is no possibility that the intersecting vehicle m will enter the reduced intersecting determination range AR. In the scene of FIG. 10, the intersecting vehicle m is actually moving toward vehicle X, but the vehicle X determines that there is no possibility that the intersecting vehicle m will enter the uniformly reduced intersecting determination range AR and suppresses the approach suppression control. In this case, the vehicle X suppresses the approach suppression control for the intersecting vehicle m, which is originally a target for which the approach suppression control is required to be executed. In this way, uniformly reducing the intersecting determination range AR can result in an inappropriate longitudinal length of the intersecting determination range AR.

FIG. 11 is an explanatory diagram of the intersecting determination range set in the present embodiment. To resolve the above-described problem, the driving assistance device 100 in the present embodiment decides the longitudinal length L based on the position of the intersecting vehicle m and the margin time, and appropriately sets the magnitude of the intersecting determination range AR. For example, the driving assistance device 100 sets the intersecting determination range AR with the longitudinal length L longer than that in FIG. 10 described above within the range of the upper limit A or less in accordance with the margin time as shown in FIG. 11.

The intersecting determiner 120 generates the predicted route R based on information about the intersecting vehicle m. The intersecting determiner 120 determines whether or not there is a possibility that the intersecting vehicle m will enter the intersecting determination range AR based on the predicted route R and the intersecting determination range AR. In the case of FIG. 11, the intersecting determiner 120 determines that there is a possibility that the intersecting vehicle m will enter the intersecting determination range AR, and the controller 130 outputs a warning (or executes the approach suppression control).

As described above, when the intersecting object is located at a position separated from the mobile object in the travel direction by a predetermined distance or more, the intersecting determiner 120 can appropriately set the intersecting determination range by varying the degree of reduction of the longitudinal length based on the margin time and reducing the intersecting determination range and can appropriately determine whether or not there is a possibility that the intersecting object will enter the intersecting determination range. For example, when the vehicle M is about to enter an intersection, if it is determined that the intersecting vehicle m is located at a position that is a distance greater than or equal to the predetermined distance PL away therefrom, the intersecting determination range can be appropriately reduced based on the margin time to set an appropriate magnitude according to the margin time for the intersecting determination range. For example, when the margin time TTC is relatively short, the longitudinal length L is set to a long length, such that it is possible to appropriately provide a warning for the intersecting vehicle m with a high possibility of approach. When the margin time TTC is relatively long, the longitudinal length L is set to a short length, such that it is possible to appropriately suppress a warning for the intersecting vehicle m with a relatively low possibility of approach.

When the intersecting vehicle m is located within a predetermined distance, the longitudinal length L is set to the predetermined distance (upper limit), such that it is possible to provide an appropriate warning for the intersecting vehicle m with a high possibility of approach. Even if the intersecting vehicle m is located at a position that is the predetermined distance or more away therefrom and the margin time TTC is less than or equal to the threshold, the longitudinal length L is set to the upper limit, such that it is possible to appropriately provide a warning for the intersecting vehicle m with a high possibility of approach.

### Regarding parameter generation

The parameter of the longitudinal length L in the reference information 182 is generated based on the error distance. For example, the parameter may be obtained by subtracting the error distance at each margin time TTC from a predetermined length (set distance C). In other words, the longitudinal length L at the margin time TTC is obtained by subtracting the product of the error distance per unit time (erroneously detected lateral component) and the margin time TTC from the set distance C. The parameter may be derived using the error distance, and may also be derived by calculations different from the above.

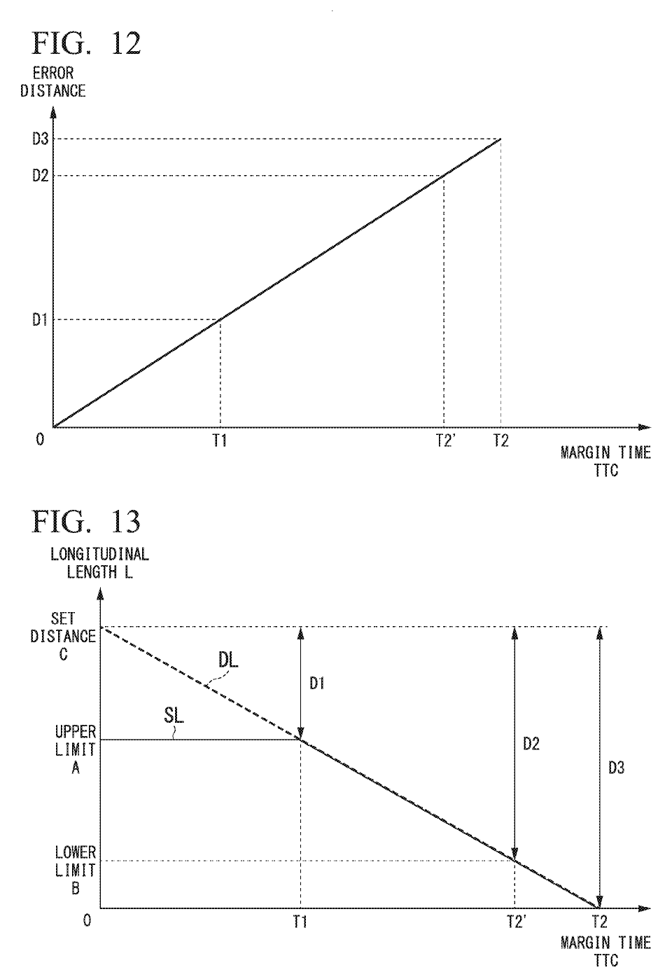

FIG. 12 is a diagram showing an example of a correlation between the error distance and the margin time TTC. The vertical axis represents the error distance and the horizontal axis represents the margin time TTC. A value of the error distance increases as a value of the margin time TTC increases. A relationship between the error distance and the margin time TTC in FIG. 12 is an example of an “error index.” The “error index” is the lateral movement speed of the erroneously detected intersecting object relative to its travel direction.

The magnitude of the error distance based on the margin time TTC in FIG. 12 will be specifically described. When the value of the margin time TTC is time T1, a value of the error distance is D1. When the value of the margin time TTC is time T2’, the value of the error distance is D2. When the value of the margin time TTC is time T2, the value of the error distance is D3.

FIG. 13 is a diagram showing an example of content of the reference information 182. FIG. 13 shows the correlation between the longitudinal length L and the margin time TTC. The vertical axis represents the longitudinal length L, and the horizontal axis represents the margin time TTC.

The parameter for the longitudinal length L is a value obtained by subtracting the error distance at each margin time TTC from the set distance C. In this case, the correlation between the longitudinal length L and the margin time TTC is indicated by a dashed line DL. In FIG. 13, when the margin time TTC is time T1, the upper limit A of the longitudinal length L is a value obtained by subtracting the error distance D1 from the set distance C. When the margin time TTC is time T2’, the lower limit B which is the value of the longitudinal length L is a value obtained by subtracting the error distance D2 from the set distance C. When the margin time TTC is time T2, the longitudinal length L is 0, which is a value obtained by subtracting the error distance D3 from the set distance C. That is, when the margin time TTC is time T2, the error distance is a value equivalent to the set distance C.

However, if the longitudinal length L is uniformly set as the distance obtained by subtracting the error distance at the margin time from the set distance C, the upper limit is set because the longitudinal length of the intersecting determination range may become excessively long. The upper limit, for example, may be decided according to the margin time TTC, or may be a predetermined distance. For example, in FIG. 13, the upper limit is set to the upper limit A. In the correlation between the longitudinal length L and the margin time TTC indicated by the dashed line DL in FIG. 13, when Set distance C > Predetermined distance (upper limit A), Longitudinal length L > Upper limit A if the value of the margin time TTC is less than a predetermined value (or less than time T1). If an upper limit for the longitudinal length L is set, the longitudinal length L is set to the upper limit A when the value of the margin time TTC is less than the value of the margin time TTC at which the longitudinal length L is equivalent to the upper limit A. In FIG. 13, the value of the margin time TTC serving as the value at which the longitudinal length L is equivalent to the upper limit A is time T1. That is, when the value of the margin time TTC is greater than or equal to 0 and less than time T1, the value of the longitudinal length L is the upper limit A. In this case, the correlation between the longitudinal length L and the margin time TTC is indicated by the solid line SL.

The correlation between the longitudinal length L and the margin time TTC indicated by the solid line SL in FIG. 13 is the same as the correlation between the longitudinal length L and the margin time TTC shown in FIG. 6.

By generating the reference information 182 using the above-described method, the vehicle M can set the intersecting determination range with reference to a parameter indicating an appropriate longitudinal length L according to the margin time TTC.

According to the above-described embodiment, the driving assistance device 100 variably reduces the intersecting determination range based on the position of the intersecting vehicle m relative to the vehicle M and the margin time. Thereby, an appropriate intersecting determination range can be set.

The embodiment described above can be represented as follows.

A mobile object control device including:

a storage device storing a program; and

a hardware processor, the hardware processor executing the program stored in the storage device to:

recognize a physical object near a mobile object;

determine whether or not there is a possibility that an intersecting object intersecting a travel direction of the mobile object will enter an intersecting determination range that is an area set in front of the mobile object when the intersecting object is located near the mobile object based on a recognition result; and

when the intersecting object is located at a position separated from the mobile object in the travel direction by a predetermined distance or more, vary a degree of reduction of a longitudinal length, which is a length in a longitudinal direction of the intersecting determination range, based on a margin time predicted as a period of time until a reference position of the intersecting object reaches a reference position set for the mobile object in a process of reducing the intersecting determination range.

Although modes for carrying out the present invention have been described using embodiments, the present invention is not limited to the embodiments and various modifications and substitutions can also be made without departing from the scope and spirit of the present invention.

What is claimed is:

1. A mobile object control device comprising:
a storage medium storing computer-readable instructions; and
one or more processors connected to the storage medium, the processor executing the computer-readable instructions to:
recognize a physical object near a mobile object and thereby obtaining a recognition result;
determine whether or not there is a possibility that an intersecting object intersecting a travel direction of the mobile object will enter an intersecting determination range that is an area set in front of the mobile object when the intersecting object is located near the mobile object based on the recognition result; and
when the intersecting object is located at a position separated from the mobile object in the travel direction by a predetermined distance or more, perform a process for reducing the intersecting determination range, wherein
the process is to vary a degree of reduction of a longitudinal length, which is a length in a longitudinal direction of the intersecting determination range, based on a margin time predicted as a period of time until a reference position of the intersecting object reaches a reference position set for the mobile object.

2. The mobile object control device according to claim 1, wherein
the processor executes the computer-readable instructions to increase the degree of reduction as the margin time increases.

3. The mobile object control device according to claim 2, wherein
the processor executes the computer-readable instructions to:
when the margin time is shorter than a reference time, set the length of the intersecting determination range to a predetermined length or more; and
when the margin time is greater than or equal to the reference time, set the length of the intersecting determination range to less than the predetermined length and increase the degree of reduction as the margin time increases.

4. The mobile object control device according to claim 3, wherein
the processor executes the computer-readable instructions to:
when the intersecting object is not separated from the mobile object in the travel direction by the predetermined distance or more, set the length of the intersecting determination range to the predetermined length; and
when the intersecting object is separated from the mobile object in the travel direction by the predetermined distance or more, decide the length of the intersecting determination range based on the margin time.

5. The mobile object control device according to claim 1, wherein
the processor executes the computer-readable instructions to change the longitudinal length based on an error distance, and
the error distance is a length calculated based on the margin time and an error index indicating a degree of error detection of the recognition or a sensor configured to provide information about the intersecting object.

6. The mobile object control device according to claim 5, wherein
the error index is a movement speed of a lateral direction relative to a travel direction of the intersecting object that is erroneously detected.

7. The mobile object control device according to claim 5, wherein
the processor executes the computer-readable instructions to variably reduce the longitudinal length by subtracting the error distance from a predetermined length,
the predetermined length is a length of a target range in which the intersecting object is detected in a forward intersecting notification, and
the forward intersecting notification is a process of providing a notification of approaching of the intersecting object that is likely to intersect a forward direction of the mobile object when the mobile object is moving at a low speed or is stopped.

8. The mobile object control device according to claim 5, wherein
the processor executes the computer-readable instructions to variably reduce the longitudinal length based on a predetermined length and the error length, and set an upper limit of the longitudinal length, the upper limit being shorter than the predetermined length.

9. The mobile object control device according to claim 8, wherein
the processor executes the computer-readable instructions to set the upper limit greater than a width of one lane in a width direction and less than a width of three lanes in a width direction using the lane width as a reference.

10. The mobile object control device according to claim 1, wherein
the processor executes the computer-readable instructions to control the mobile object so that the mobile object and the intersecting object do not approach each other when it is determined that there is a possibility that the intersecting object will enter the intersecting determination range.

11. The mobile object control device according to claim 10, wherein
the processor executes the computer-readable instructions to suppress the approach by executing one or more of (A) a process of controlling a speed of the mobile object, (B) a process of controlling steering of the mobile object, and (C) a process of outputting a warning for a driver of the mobile object.

12. A mobile object control method comprising:
recognizing, by a computer, a physical object near a mobile object;
thereby obtaining, by a computer, a recognition result;
determining, by the computer, whether or not there is a possibility that an intersecting object intersecting a travel direction of the mobile object will enter an intersecting determination range that is an area set in front of the mobile object when the intersecting object is located near the mobile object based on the recognition result; and
when the intersecting object is located at a position separated from the mobile object in the travel direction by a predetermined distance or more, performing, by a computer, a process for reducing the intersecting determination range, wherein
the process is to vary a degree of reduction of a longitudinal length, which is a length in a longitudinal direction of the intersecting determination range, based on a margin time predicted as a period of time until a reference position of the intersecting object reaches a reference position set for the mobile object.

13. A non-transitory storage medium storing a program for causing a computer to execute:
a process of recognizing a physical object near a mobile object and thereby obtaining a recognition result;
a process of determining whether or not there is a possibility that an intersecting object intersecting a travel direction of the mobile object will enter an intersecting determination range that is an area set in front of the mobile object when the intersecting object is located near the mobile object based on the recognition result; and
a reduction process of performing, when the intersecting object is located at a position separated from the mobile object in the travel direction by a predetermined distance or more, a process for reducing the intersecting determination range, wherein
the reduction process is to vary a degree of reduction of a longitudinal length, which is a length in a longitudinal direction of the intersecting determination range, based on a margin time predicted as a period of time until a reference position of the intersecting object reaches a reference position set for the mobile object.
